(19) United States
(12) Patent Application Publication
(10) Pub. No.: US 2026/0274639 A1
(43) Pub. Date: Sep. 17, 2026

(54) CAROUSEL MACHINE FOR A TREATMENT STATION

(71) Applicant: SIDEL PARTICIPATIONS, Octeville-sur-Mer (FR)

(72) Inventors: Yves-Alban DUCLOS, OCTEVILLE- SUR-MER (FR); Geoffroy VAUDOR, OCTEVILLE- SUR-MER (FR)

(21) Appl. No.: 19/566,201

(22) Filed: Mar. 13, 2026

(30) Foreign Application Priority Data
Mar. 14, 2025 (FR) 2502458

(51) Int. Cl. B67C 9/00

(52) U.S. Cl. CPC B67C 9/00

(57) ABSTRACT

Provided are a carousel machine and methods for creating a vacuum in a container that is to be treated by the carousel machine. The machine includes at least one treatment station having at least one evacuation volume and a plurality of pressure sources. The evacuation volume is placed, successively and for a predetermined duration, in fluidic communication with each pressure source via at least one associated pipe associated with each pressure source and an airtight rotary coupling. The pressure in the evacuation volume is progressively reduced by establishing successive fluidic communications. The predetermined duration of fluidic communication between the evacuation volume and at least one associated pipe is substantially less than or is equal to the time taken for equilibrium between the pressure in the evacuation volume and the pressure in the associated pipe to become established.

### CROSS-REFERENCE TO RELATED APPLICATIONS

This application claims the benefit of French Application No. FR2502548, filed Mar. 14, 2025, the entire contents of which is hereby incorporated herein by reference.

### BACKGROUND

Document WO 00/58631 describes a carousel machine in which an evacuation volume of a container accepted by the carousel machine is placed in fluidic communication with a plurality of pressure sources in order to reduce the pressure in the container so that a treatment can be performed in said container. This treatment is drawn to the application of a coating to the inside of the container by means of a low-pressure plasma. Such a treatment requires a pressure close to a vacuum to be created inside the container. In order to achieve this, the evacuation volume inside the container is placed, successively, in fluidic communication with a plurality of pressure sources so as to reduce the pressure in the container progressively with each fluidic communication. Each fluidic communication is established for the time needed for the pressure source to evacuate substantially all of the volume that it is capable of evacuating, before moving on to another pressure source that has a higher volumetric flow rate.

Although the carousel machine described in that document is able to create a vacuum in a container quickly and for a reasonable cost, there is a constant search to obtain a higher processing rate, notably by accelerating the creation of the vacuum in the container without increasing the costs connected with this step.

One of the objectives of the present invention is to meet these requirements by proposing a carousel machine capable of reducing the pressure in an evacuation volume in a shorter space of time. It is to the provision of meeting these and other needs that the present invention is primarily directed.

### SUMMARY

Embodiments of the present disclosure provide a carousel machine for treating at least one container, the carousel machine including at least one treatment station configured to accept the at least one container, at least one evacuation volume, and a plurality of pressure sources. Each of the at least one evacuations volume can be placed, successively and for a predetermined duration, in fluidic communication with each pressure source via at least one associated pipe associated with each pressure source and an airtight rotary coupling, wherein each of the at least one associated pipes extends between the respective pressure source and the airtight rotary coupling. The pressure in the evacuation volume is progressively reduced by establishing the successive fluidic communications between the evacuation volume and the associated pipes associated with the pressure sources. The predetermined duration of fluidic communication between the evacuation volume and at least one associated pipe associated with one of the pressure sources is substantially less than or is equal to a time taken for equilibrium between a pressure in said evacuation volume and a pressure in said associated pipe to become established.

An embodiment of the present disclosure also includes a method for creating a vacuum in a container that is to be treated by a carousel machine as described above. The method can include placing the container in a treatment station of the carousel machine, an internal volume of the container and a volume of an included pipe extending between the internal volume and an airtight rotary coupling forming one evacuation volume of said treatment station. The method can further include placing the evacuation volume in fluidic communication with an associated pipe associated with a first pressure source from among a plurality of pressure sources for a first predetermined duration that is less than or equal to a time taken for equilibrium between a pressure in the evacuation volume and a pressure in said associated pipe to become established, the pressure in the evacuation volume decreasing down to a first reduced pressure during said first predetermined duration. The method can then include placing the evacuation volume at the first reduced pressure in fluidic communication with an associated pipe associated with a second pressure source from among the plurality of pressure sources for a second predetermined duration, the pressure in the evacuation volume decreasing, from the first reduced pressure to a second reduced pressure that is lower than the first reduced pressure, during said second predetermined duration.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a schematic depiction of a carousel machine according to various example embodiments;

FIG. 2 is a schematic depiction of the principle of establishing fluidic communication between a treatment station and a pressure source for implementing the carousel machine;

FIG. 3 is a schematic depiction of part of the carousel machine of FIG. 1;

FIG. 4 is a collection of graphs showing how the control of the carousel machine according to various embodiments affects the pressure in an evacuation volume and in piping associated with a pressure source.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

### General Discussion

In accordance with the purpose(s) of the present disclosure, as embodied and broadly described herein, embodiments of the present disclosure, in some aspects, relate to a carousel machine for treating at least one container, of the type comprising at least one treatment station configured to accept the container and comprising at least one evacuation volume, and a plurality of pressure sources, the evacuation volume being placed, successively and for a predetermined duration, in fluidic communication with each pressure source by means of at least one associated pipe associated with each pressure source and an airtight rotary coupling, said associated pipe extending between the associated pressure source and the airtight rotary coupling, the pressure in said evacuation volume being progressively reduced by the establishing of the successive fluidic communications between said evacuation volume and said associated pipes associated with the pressure sources. The invention also relates to a method for creating a vacuum in a container that is to be treated by means of such a carousel machine.

To this end, the invention relates to a carousel machine of the aforementioned type, wherein the predetermined duration of fluidic communication between the evacuation volume and at least one associated pipe associated with one of the pressure sources is substantially less than or is equal to the time taken for equilibrium between the pressure in said evacuation volume and the pressure in said associated pipe to become established.

By limiting the predetermined duration for which the evacuation volume is placed in fluidic communication with the associated pipe associated with one of the pressure sources to a duration that is less than or equal to the time needed for equilibrium between the pressure in the evacuation volume and the pressure in the associated pipe to become established, this predetermined duration is reduced to a period for which the pressure in the evacuation volume is being reduced at a particularly high speed without waiting for the next phase, after which pressure equilibrium has become established and during which the reduction in pressure occurs at an ever decreasing rate. By placing the evacuation volume in fluidic communication with the next pressure source at the end of this predetermined duration, the rate at which the pressure in the container is reduced is greatly accelerated without having to increase costs by increasing the pumping capacity of the pressure sources for example.

The carousel machine according to the invention may also comprise one or more of the following features, taken on their own or in any technically conceivable combination:
the carousel machine comprises a wheel rotating the treatment station so as to place the evacuation volume successively in fluidic communication with each associated pipe associated with each pressure source over an angular sector associated with each associated pipe, at least one of the angular sectors having an angular dimension such that the evacuation volume is placed in fluidic communication with the associated pipe for the predetermined duration when the treatment station passes through said angular sector;
the successive communication established between the evacuation volume and each associated pipe is achieved using a plurality of valves;
the treatment station comprises two mutually isolated evacuation volumes, each of said evacuation volumes being placed, successively and for a predetermined duration, in fluidic communication with an associated pipe associated with each pressure source, the pressure in said evacuation volumes being progressively reduced by establishing successive fluidic communications between said evacuation volumes and said associated pipes;
the successive fluidic communications established between the evacuation volumes and the associated pipes are devised so that the pressures in the evacuation volumes are reduced while keeping the difference between said pressures below a predetermined threshold;
the treatment station comprises a chamber accommodating the container accepted by said treatment station, one of the evacuation volumes being formed by the internal volume of the container placed inside the chamber and by the volume of an included pipe extending between the internal volume and the airtight rotary coupling, and the other evacuation volume being formed by the internal volume of the chamber around the container placed in the chamber and by the volume of an included pipe extending between the internal volume of the chamber and the airtight rotary coupling;
the plurality of pressure sources comprises at least a first pumping unit comprising at least one pump, and a second pumping unit comprising at least one pump, the evacuation volume being placed in fluidic communication with the first pumping unit and then with the second pumping unit, the pump of the first pumping unit having a volumetric flow rate that is lower than the volumetric flow rate of the pump of the second pumping unit;
the carousel machine comprises a plurality of treatment stations each comprising at least one evacuation volume, said evacuation volumes being placed successively, and for a predetermined duration, in fluidic communication with each pressure source one after another;
the evacuation volume is placed simultaneously, and for a predetermined moment, in fluidic communication with two pressure sources, said predetermined moment being shorter than the predetermined duration that is less than or equal to the time taken for equilibrium between the pressure in said evacuation volume and the pressure in the associated pipe associated with one of the two pressure sources to become established; at least one of the pressure sources is associated with two associated pipes extending between said pressure source and the airtight rotary coupling, the pressures in said associated pipes being different from one another prior to fluidic communication being established between each of said associated pipes and the evacuation volume.

According to another aspect, the invention also relates to a method for creating a vacuum in a container that is to be treated by means of a carousel machine as described hereinabove, the method comprising at least the following steps: placing the container in a treatment station of the carousel machine, the internal volume of the container and the volume of an included pipe extending between the internal volume and the airtight rotary coupling forming one evacuation volume of said treatment station,
placing said evacuation volume in fluidic communication with an associated pipe associated with a first pressure source from among the plurality of pressure sources for a first predetermined duration that is less than or equal to the time taken for equilibrium between the pressure in said evacuation volume and the pressure in said associated pipe to become established, the pressure in the evacuation volume decreasing down to a first reduced pressure during said first predetermined duration,
placing the evacuation volume at the first reduced pressure in fluidic communication with an associated pipe associated with a second pressure source from among the plurality of pressure sources for a second predetermined duration, the pressure in the evacuation volume decreasing, from the first reduced pressure to a second reduced pressure that is lower than the first reduced pressure, during said second predetermined duration.

The method for creating a vacuum according to the invention may comprise one or more of the following features, taken on their own or in combination:
the pressure in the evacuation volume is reduced down to a pressure less than or equal to 0.3 mbar by placing said evacuation volume successively in fluidic communication with at least one associated pipe associated with each pressure source from among the plurality of pressure sources;
the container is placed in a chamber of the treatment station, the internal volume of the container and the volume of the included pipe forming a first evacuation volume of said treatment station, and the internal volume of the chamber around the container and the volume of an included pipe extending between the internal volume of the chamber and the airtight rotary coupling forming a second evacuation volume of said treatment station, said second evacuation volume being placed in fluidic communication with a pressure source of the plurality of pressure sources before or at the same time as the first evacuation volume is placed in fluidic communication with said pressure source.

Turning now to the drawings, exemplary embodiments are described in detail.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

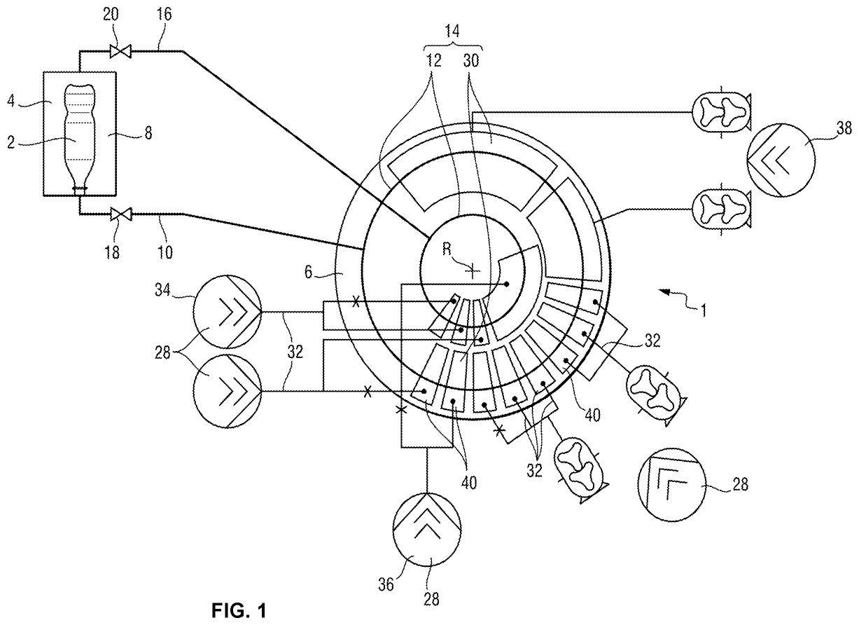

A carousel machine 1 for treating at least one container 2 is described with reference to FIG. 1.

Such a container 2 is, for example, a bottle or vial made from a synthetic material and to the inside of which a coating is to be applied, for example using a low-pressure plasma. Such a coating is more particularly intended to give the container a barrier effect in order to render it more impermeable to gases. Such a surface treatment applied to the container 2 is for example disclosed in document WO 99/49991, to which a person skilled in the art may refer for further information regarding the use of a plasma.

The carousel machine 1 comprises at least one treatment station 4 devised for accepting the container 2. The treatment station 4 is for example carried by a wheel 6, or carousel, able to rotate about an axis of rotation R. Conventionally, the wheel 6 carries a plurality of treatment stations 4 each devised to accept a container 2 so that the treatment can be performed on a succession of containers 2 one after another.

Each treatment station 4 comprises a chamber 8 devised to accept the container 2. The treatment station 4 defines at least one evacuation volume, for example formed by the internal volume of the container 2 when it is accepted in the chamber 8, and by the volume of an included pipe 10 extending between the internal volume of the container 2 and the mobile part 12 of an airtight rotary coupling 14 described in greater detail later. According to one embodiment, this evacuation volume is a first evacuation volume of the treatment station 4, and the treatment station 4 defines a second evacuation volume, formed by the internal volume of the chamber 8 around the container 2 and by the volume of an included pipe 16 extending between the internal volume of the chamber 8 and the mobile part 12 of the airtight rotary coupling 14. In that case, the first evacuation volume and the second evacuation volume are mutually isolated.

Each treatment station 4 further comprises, for example, at least one valve 18 arranged between the container 2 and the included pipe 10 in order to block or allow fluidic communication between the internal volume of the container 2 and this included pipe. Where applicable, each of the one or more treatment stations 4 further comprises, for example, at least one valve 20 arranged between the chamber 8 and the included pipe 16 in order to block or allow fluidic communication between the internal volume of the chamber 8 and this included pipe 16.

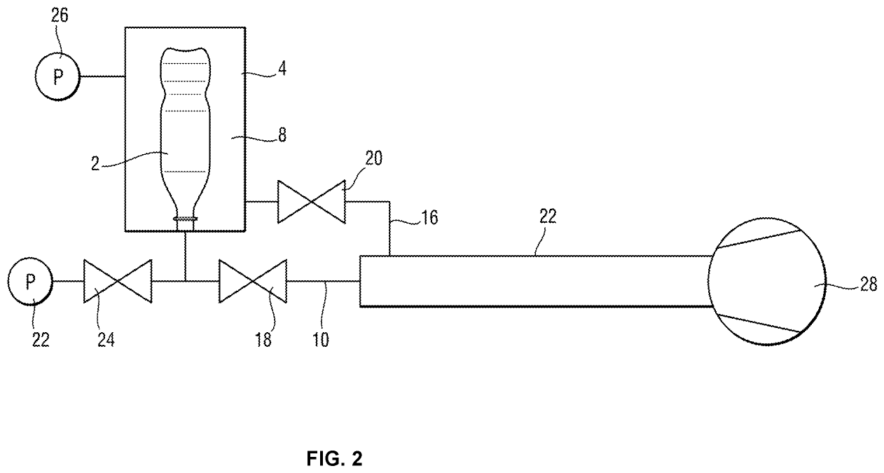

As depicted in FIG. 2, the treatment station 4 may also comprise a pressure sensor 22 that senses the pressure in the internal volume of the container 2, with a valve 24 interposed between this pressure sensor 22 and the internal volume of the container and/or a pressure sensor 26 that senses the pressure in the internal volume of the chamber 8.

The carousel machine 1 further comprises a plurality of pressure sources 28 able to pump out the evacuation volume(s) of the or each treatment station 4, as will be described in greater detail later. Each pressure source 28 is coupled to a fixed part 30 of the airtight rotary coupling 14 by at least one associated pipe 32 associated with the pressure source 28.

In the known way, the airtight rotary coupling 14 enables fluidic communication to be established between the included pipes 10, 16 of the treatment station(s) 4 and the associated pipes 32 associated with the pressure sources 28 so that fluidic communication is thus established between the evacuation volumes and the pressure sources 28. In other words, the rotary airtight coupling 14 enables airtight fluidic communications to be established between moving parts, namely the treatment stations 4, and fixed parts, namely the pressure sources 28, of the carousel machine 1. More particularly, the airtight rotary coupling 14 enables a treatment station 4 to be placed in fluidic communication with all the pressure sources 28 in succession as the treatment station 4 is gradually rotated by the wheel 6. The principle of such an airtight rotary coupling 14 and of establishing successive fluidic communications between a treatment station 4 and a plurality of pressure sources 28 is described in document WO 00/58631; the person skilled in the art may refer to that document for further details concerning this principle.

The plurality of pressure sources 28 comprises for example at least a first pumping unit 34 comprising at least one pump, and a second pumping unit 36 comprising at least one pump. According to one embodiment and as depicted in FIG. 1, the plurality of pressure sources 28 comprises more than two pumping units, each pumping unit comprising at least one pump. When a treatment station 4 accepting a container 2 is rotated by the wheel 6, the evacuation volume(s) of the treatment station 4 are successively placed in fluidic communication with the first pumping unit 34 and then with the second pumping unit 36, and then with the subsequent pumping unit(s), where applicable.

At least the first and second pumping units 34, 36 are devised to reduce the pressure in the evacuation volume(s) of the treatment station 4 when these evacuation volumes are in fluidic communication with the first pumping unit 34 and with the second pumping unit 36, respectively. In other words, during these fluidic communications, the pump(s) of the first and of the second pumping units 34, 36 pump air out of the evacuation volume(s) of the treatment station in order to reduce the pressure in these volumes.

Thus, the first pumping unit 34 is devised to reduce the pressure in the evacuation volume(s) from an initial pressure, for example equal to atmospheric pressure, down to a first reduced pressure, lower than the initial pressure. The second pumping unit 36 is itself devised to reduce the pressure from the first reduced pressure down to a second reduced pressure lower than the first reduced pressure.

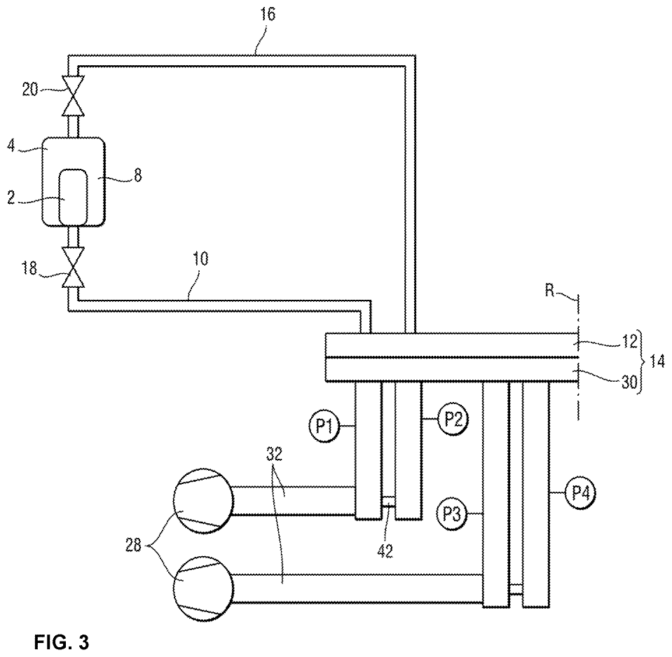

According to one embodiment, at least one of the pumping units comprises a pump and at least one associated pipe 32 for establishing fluidic communication with the first evacuation volume so as to reduce the pressure in the first evacuation volume, and another pomp and at least one associated pipe 32 for establishing fluidic communication with the second evacuation volume, as depicted in FIG. 3. As a variant or in addition, the one same pump is associated with an associated pipe 32 placed in fluidic communication with the first evacuation volume and with another associated pipe 32 placed in fluidic communication with the second evacuation volume, as depicted in FIG. 3.

Given that the lower the pressure in an evacuation volume the more difficult it is to reduce this pressure further, the pump(s) of the second pumping unit 36 advantageously have a volumetric flow rate that is higher than that of the first pumping unit 34. Such an arrangement in pumping units with increasing volumetric flow rates notably makes it possible to reduce the costs associated with the pumping power needed to lower the pressure in the evacuation volumes, notably down to a pressure close to a vacuum. Specifically, with such an arrangement, one or more pumps having a relatively low volumetric flow rate can be used in a phase in which reducing the pressure does not require a high pumping power, such as is the case for passing from the initial pressure to the first reduced pressure, and one or more pumps having a relatively high volumetric flow rate can be used in a phase in which reducing the pressure requires a high pumping power, as is the case for passing from the first reduced pressure to the second reduced pressure.

With this arrangement, when more than two pumping units are provided, the pumping units arranged after the second pumping unit have increasing volumetric flow rates. The number of pumping units is chosen so that the pressure in the container is reduced down to a pressure close to a vacuum, for example below 0.3 mbar, by reaching a compromise between the space available for establishing the fluidic communications between the treatment station 4 and the pumping units as the treatment station 4 rotates with the wheel 6, and the progressive increase in volumetric flow rate needed to achieve the desired pressure in the container 2.

According to one embodiment, the carousel machine 1 comprises at least one pressure-maintaining pumping unit 38 that maintains the pressure in the container 2 once the desired pressure has been reached. In other words, this pressure-maintaining pumping unit 38 does not reduce the pressure in the evacuation volume(s) further but maintains it at the desired pressure(s). Such a pressure-maintaining pumping unit 38 is then arranged as being the last pumping unit with which the treatment station is placed in fluidic communication. In addition, it is during this fluidic communication with the pressure-maintaining pumping unit 38 that the treatment is performed on the container 2 accommodated in the treatment station 4 such that this treatment is performed at low pressure.

As indicated previously, the pressure in the container 2 is reduced by the successive pumping units until it reaches a pressure close to a vacuum, for example below 0.3 mbar, and more particularly comprised between 0.02 mbar and 0.3 mbar, for example substantially equal to 0.1 mbar.

Moreover, in order to avoid the container 2 becoming deformed under the effect of the partial vacuum inside it, the pressure in the internal volume of the chamber 8, namely in the second evacuation volume, is reduced progressively with that of the inside of the container 2, namely that of the first evacuation volume. In other words, the successive fluidic communications established between the evacuation volumes and the associated pipes associated with the pressure sources 28 are devised so that the pressures in the evacuation volumes, namely in the first evacuation volume and in the second evacuation volume, are reduced while keeping the difference between said pressures below a predetermined threshold. More particularly, the progressive reductions in pressure in the first evacuation volume and in the second evacuation volume are devised so that the difference in pressure between the first evacuation volume and the second evacuation volume is less than or equal to 100 mbar, and more particularly substantially equal to 50 mbar. This pressure difference is such that the pressure in the second evacuation volume is higher than the pressure in the first evacuation volume.

The fluidic communication between an evacuation volume and an associated pipe 32 associated with a pressure source 28 is established for a predetermined duration corresponding to the time needed for the pressure in the evacuation volume to be reduced down to the desired pressure by the end of this fluidic communication. Thus, for the first pumping unit 34, the predetermined duration for which fluidic communication is established between the first evacuation volume and at least one associated pipe 32 associated with the first pumping unit corresponds to the time necessary to pass from the initial pressure to the first reduced pressure. Since the fluidic communication is established while the treatment station 4 is rotating with the wheel 6, the predetermined duration thus corresponds to an angular sector 40 of the rotation of the wheel 6. Thus, by adjusting the angular sector over which fluidic communication between an evacuation volume and an associated pipe 32 associated with a pressure source 28 is established, using the principle described for example in document WO 00/58631, the predetermined duration can be regulated, notably with consideration to the volumetric flow rate of the pump coupled to the associated pipe.

As a variant, the successive fluidic communications of predetermined duration are achieved by successive valves rather than angular sectors as described in the above-mentioned document.

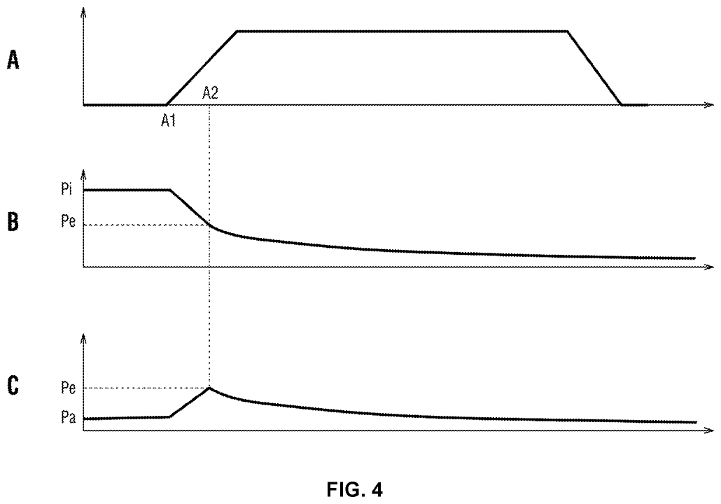

The choice of a predetermined duration suitable for rapidly reducing the pressure in the evacuation volume(s), notably using the first pumping unit 34, will now be described with reference to FIG. 4. FIG. 4 represents, in graph A, the command for establishing fluidic communication between an evacuation volume and an associated pipe 32 associated with a pressure source 28, as a function of time. Graph B represents the pressure in this evacuation volume, and graph C the pressure in this associated pipe.

When the treatment station 4 enters the corresponding angular sector 40, fluidic communication begins to be established at point A1 of graph A while the pressure in the evacuation volume is equal to an initial pressure Pi (graph B) and the pressure in the associated pipe is equal to a suction pressure Pa (graph C). The suction pressure Pa in the associated pipe is due to the action of the pressure source 28 which sucks air into the associated pipe 32.

When fluidic communication between the evacuation volume and the associated pipe 32 is established at point A1, the pressure source 28 sucks air from the evacuation volume via the associated pipe 32, which leads to a drop in the pressure in the evacuation volume and to an increase in the pressure in the associated pipe until such point as equilibrium, at a pressure Pe between the evacuation volume and the associated pipe 32, is reached, at point A2. As may be seen from graph B, the reduction in the pressure in the evacuation volume from the initial pressure Pi to the equilibrium pressure Pe between points A1 and A2 is achieved particularly quickly.

When the fluidic communication is maintained beyond point A2, it may be noted that the pressure in the evacuation volume continues to fall while the pressure in the associated pipe drops back down towards the suction pressure Pa. However, as visible in graphs B and C, this drop in pressure occurs far less quickly.

Thus, according to the invention, the predetermined duration for which the evacuation volume is in fluidic communication with the associated pipe 32 (and therefore the angular magnitude of the corresponding angular sector 40) is chosen to be less than or equal to the time taken for equilibrium, at the pressure Pe, between the pressure in the evacuation volume and the pressure in the associated pipe 32 to become established. In other words, with reference to the graphs of FIG. 4, the predetermined duration is chosen to be between points A1 and A2 of graph A, which corresponds to the phase during which the pressure in the evacuation volume decreases quickly. As a preference, the predetermined duration is chosen to be as close as possible for the time needed for the equilibrium pressure Pe to become established, namely as close as possible to point A2. In other words, fluidic communication is established only during the phase of rapid pressure drop in the evacuation volume, and not beyond.

This same principle is applied for example for the establishment of fluidic communication between the second evacuation volume and an associated pipe 32 of the first pumping unit 34.

According to one embodiment, this principle is also applied to the predetermined duration for which the evacuation volume(s) are in fluidic communication with the associated pipe(s) 32 of the second pumping unit and/or the additional pumping units not including the pressure-maintaining pumping unit(s) 38.

It is thus possible to reduce the pressure in the evacuation volume(s) particularly quickly by limiting at least certain fluidic communications established between an evacuation volume and a pressure source 28 to a duration for which the drop in pressure in the evacuation volume is in its rapid phase prior to or up to the establishment of equilibrium between the pressures in the evacuation volume and the associated pipe 32.

According to one embodiment that enables the reduction in pressure in the evacuation volume to be speeded up still further, the evacuation volume is, for a predetermined moment, in fluidic communication with two adjacent pressure sources 28 simultaneously. This predetermined moment is shorter than the predetermined duration that is less than or equal to the time taken for equilibrium between the pressure in the evacuation volume and the pressure in the associated pipe 32 associated with one of the two pressure sources 28 to become established. In other words, the evacuation volume is placed in fluidic communication with one pressure source 28 while the pressure in the evacuation volume has not yet reached equilibrium with the pressure in the associated pipe 32 associated with the other pressure source 28. Thus, the simultaneous fluidic communication with the two successive pressure sources 28 is established during the phase of rapid pressure drop in the evacuation volume, both with one of the associated pipes 32 and with the other associated pipe 32 associated with these two pressure sources 28.

According to one embodiment, depicted in FIG. 3, that enables the costs associated with the pumping power needed to achieve the reduced pressure in the evacuation volume to be reduced still further, at least one pressure source 28 is associated with two associated pipes 32 between the pressure source and the rotary coupling 14 for establishing successive fluidic communication with the same evacuation volume. The pressures in these associated pipes are different from one another prior to each of these associated pipes 32 being placed in fluidic communication with the evacuation volume. In other words, the suction pressure Pa in one of these associated pipes 32 is higher than the suction pressure Pa in the other of these associated pipes 32. The evacuation volume is therefore first of all placed in fluidic communication with the associated pipe 32 in which the suction pressure is the higher, and then with the other associated pipe 32 in which the suction pressure is the lower. These successive fluidic communications therefore make it possible to reproduce the operation described hereinabove with pumps having successively increasing volumetric flow rates. In order for one of the associated pipes 32 to have suction pressure that is higher than that of the other associated pipe 32, the cross section of one of these pipes is, for example, smaller than that of the other pipe and/or a flow restrictor 42 is arranged between these two associated pipes 32. Such a restrictor 42 forms a throttling throat that mechanically increases the pressure in the associated pipe in fluidic communication with the pressure source by means of this restrictor 42. Thus, using the one same pressure source 28 it is possible to progressively reduce the pressure in an evacuation volume to a first reduced pressure using one of the associated pipes 32 and then to pass from the first reduced pressure to a second, lower reduced pressure using the other associated pipe 32.

The operation of the carousel machine 1 for reducing the pressure in a container 2 will now be described. All the steps in this operation are carried out while the treatment station is being rotated with the wheel 6.

The container 2 is first of all placed in a treatment station 4 and its internal volume is placed in fluidic communication with the included pipe 10 of this treatment station by opening the corresponding valve 18 in order to form the first evacuation volume. If applicable, the second evacuation volume is also formed by placing the internal volume of the chamber 8 around the container 2 in fluidic communication with the corresponding included pipe 16, by opening the valve 20.

The treatment station then reaches the angular sector in which the first evacuation volume is placed in fluidic communication with an associated pipe 32 of the first pumping unit 34. The pressure in the first evacuation volume is then reduced from an initial pressure Pi to a first reduced pressure that is higher than or equal to the pressure Pe of equilibrium between the first evacuation volume and this associated pipe 32 because the predetermined duration for which this fluidic communication is established is less than or equal to the time taken for equilibrium, at the pressure Pe, to become established between the pressure in the first evacuation volume and the pressure in this associated pipe 32, as described earlier.

Simultaneously with or prior to the establishing of this fluidic communication with the first evacuation volume, the second evacuation volume is placed in fluidic communication with an associated pipe 32 associated with the first pumping unit 34, for example with another pump of this first pumping unit 34, so as to reduce the pressure in the second evacuation volume such that the difference in pressure between the first evacuation volume and the second evacuation volume is kept below a predetermined threshold difference between said pressures, as described earlier. The act of placing the second evacuation volume in fluidic communication with the corresponding associated pipe 32 prior to or simultaneously with the establishing of fluidic communication between the first evacuation volume and the corresponding associated pipe 32 is achieved by offsetting the corresponding angular sectors 40 or by making these coincide. Thus, in the example of FIG. 1, in which the angular sectors 40 establishing fluidic communication between the second evacuation volume and the pumping units are offset with respect to the angular sectors 40 establishing fluidic communication between the first evacuation volume and the pumping units, the pressure in the second evacuation volume is reduced prior to the reduction in the pressure in the first evacuation volume.

Once the first reduced pressure is reached in the first evacuation volume, the first evacuation volume is placed in fluidic communication with the associated pipe 32 associated with the next pressure source 28, for example in the second pumping unit 36. This establishing of a fluidic communication may be performed using the same principle as that described earlier, namely with a predetermined duration that is less than or equal to the time taken for equilibrium between the pressure in the first evacuation volume and the pressure in this associated pipe 32 to become established. As a variant, this further establishment of fluidic communication is performed for a longer predetermined duration, namely beyond the point at which pressure equilibrium, at the pressure Pe, is reached. Specifically, for reasons of space, or when the addition of further pressure sources in order to achieve the desired pressure in the first evacuation volume cannot be justified, it may be preferable and quicker to maintain fluidic communication beyond the equilibrium pressure, until such point as the desired pressure in the first evacuation volume is reached, rather than having to provide for establishing fluidic communication with an additional pressure source.

Whatever the embodiment, the pressure in the first evacuation volume is equal to the second reduced pressure at the end of this further fluidic communication. The same principle is employed in respect of the second evacuation volume in order to maintain the difference between the first evacuation volume and the second evacuation volume, as described earlier.

If the second reduced pressure in the first evacuation volume is equal to the desired pressure close to vacuum, the first evacuation volume is then placed in fluidic communication with the pressure-maintaining pumping unit 38 and the low-pressure treatment, such as the use of a low-pressure plasma, is performed on the container 2.

If the second reduced pressure is higher than the desired pressure, one or more additional pumping units are provided to reduce the pressure in the first evacuation volume and in the second evacuation volume as described earlier until the desired pressure is reached, before passing on to the pressure-maintaining pumping unit 38.

When the carousel machine 1 comprises a plurality of treatment stations, the steps described hereinabove are implemented on the treatment stations 4 in succession, one treatment station being for example in fluidic communication with the second pumping unit 36 while the next treatment station is in fluidic communication with the first pumping unit 34.

The carousel machine 1 described hereinabove and the method for establishing a vacuum in a container employing this carousel machine make it possible quickly to achieve a pressure close to vacuum inside the container 2 while at the same time minimizing the costs connected with the pumping power needed to achieve this pressure, notably by optimizing the time for which fluidic communication is established between the evacuation volumes and one or more associated pipes 32 associated with the pressure sources 28 of the carousel machine 1.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0 ” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A carousel machine for treating at least one container, comprising:
at least one treatment station configured to accept the at least one container;
at least one evacuation volume; and
a plurality of pressure sources;
wherein each of the at least one evacuations volume is placed, successively and for a predetermined duration, in fluidic communication with each pressure source via at least one associated pipe associated with each pressure source and an airtight rotary coupling, wherein each of the at least one associated pipes extends between the respective pressure source and the airtight rotary coupling,
wherein the pressure in the evacuation volume is progressively reduced by establishing the successive fluidic communications between the evacuation volume and the associated pipes associated with the pressure sources, and
wherein the predetermined duration of fluidic communication between the evacuation volume and at least one associated pipe associated with one of the pressure sources is substantially less than or is equal to a time taken for equilibrium between a pressure in said evacuation volume and a pressure in said associated pipe to become established.

2. The carousel machine according to claim 1, further comprising a wheel rotating the at least one treatment station so as to place the evacuation volume successively in fluidic communication with each associated pipe associated with each pressure source over an angular sector associated with each associated pipe, at least one of the angular sectors having an angular dimension such that the evacuation volume is placed in fluidic communication with the associated pipe for the predetermined duration when the treatment station passes through the angular sector.

3. The carousel machine according to claim 1, wherein the successive communication established between the evacuation volume and each associated pipe is achieved using a plurality of valves.

4. Carousel machine according to claim 1, wherein the treatment station comprises two mutually isolated evacuation volumes, each of said evacuation volumes being placed, successively and for a predetermined duration, in fluidic communication with an associated pipe associated with each pressure source, the pressure in said evacuation volumes being progressively reduced by establishing successive fluidic communications between said evacuation volumes and said associated pipes.

5. Carousel machine according to claim 4, wherein the successive fluidic communications established between the mutually isolated evacuation volumes and the associated pipes are devised so that the pressures in the mutually isolated evacuation volumes are reduced while keeping a difference between said pressures below a predetermined threshold.

6. Carousel machine according to claim 4, wherein the treatment station comprises a chamber accommodating the container accepted by said treatment station, one of the mutually isolated evacuation volumes being formed by an internal volume of the container placed inside the chamber and by the volume of an included pipe extending between the internal volume and the airtight rotary coupling, and the other mutually isolated evacuation volume being formed by the internal volume of the chamber around the container placed in the chamber and by the volume of an included pipe extending between the internal volume of the chamber and the airtight rotary coupling.

7. Carousel machine according to claim 1, wherein the plurality of pressure sources comprises at least a first pumping unit comprising at least one pump, and a second pumping unit comprising at least one pump, the at least one evacuation volume being placed in fluidic communication with the first pumping unit and then with the second pumping unit, the pump of the first pumping unit having a volumetric flow rate that is lower than a volumetric flow rate of the pump of the second pumping unit.

8. Carousel machine according to claim 1, comprising a plurality of treatment stations each comprising at least one evacuation volume, each of the at least one evacuation volumes being placed successively, and for a predetermined duration, in fluidic communication with each pressure source one after another.

9. Carousel machine according to claim 1, wherein the at least one evacuation volume is placed simultaneously, and for a predetermined duration, in fluidic communication with two pressure sources, the predetermined duration being shorter than a duration that is less than or equal to the time taken for equilibrium between the pressure in said evacuation volume and the pressure in the associated pipe associated with one of the two pressure sources to become established.

10. Carousel machine according to claim 1, wherein at least one of the pressure sources is associated with two associated pipes extending between said pressure source and the airtight rotary coupling, wherein pressures in said associated pipes are different from one another prior to fluidic communication being established between each of said associated pipes and the evacuation volume.

11. A method for creating a vacuum in a container that is to be treated by a carousel machine, the method comprising at least the following steps:
placing the container in a treatment station of the carousel machine, an internal volume of the container and a volume of an included pipe extending between the internal volume and an airtight rotary coupling forming one evacuation volume of said treatment station;
placing the evacuation volume in fluidic communication with an associated pipe associated with a first pressure source from among a plurality of pressure sources for a first predetermined duration that is less than or equal to a time taken for equilibrium between a pressure in the evacuation volume and a pressure in said associated pipe to become established, the pressure in the evacuation volume decreasing down to a first reduced pressure during said first predetermined duration; and
placing the evacuation volume at the first reduced pressure in fluidic communication with an associated pipe associated with a second pressure source from among the plurality of pressure sources for a second predetermined duration, the pressure in the evacuation volume decreasing, from the first reduced pressure to a second reduced pressure that is lower than the first reduced pressure, during said second predetermined duration.

12. The method for creating a vacuum in a container that is to be treated by a carousel machine according to claim 11, wherein the pressure in the evacuation volume is reduced down to a pressure less than or equal to 0.3 mbar by placing said evacuation volume successively in fluidic communication with at least one associated pipe associated with each pressure source from among the plurality of pressure sources.

13. The method for creating a vacuum in a container that is to be treated by a carousel machine according to claim 11, wherein the container is placed in a chamber of the treatment station, the internal volume of the container and the volume of the included pipe forming a first evacuation volume of said treatment station, and the internal volume of the chamber around the container and the volume of an included pipe extending between the internal volume of the chamber and the airtight rotary coupling forming a second evacuation volume of said treatment station, said second evacuation volume being placed in fluidic communication with a pressure source of the plurality of pressure sources before or at the same time as the first evacuation volume is placed in fluidic communication with said pressure source.
